(19) United States
(12) Patent Application Publication
(10) Pub. No.: US 2009/0030757 A1
(43) Pub. Date: Jan. 29, 2009

(54) Content Distribution for Mobile Phones

(76) Inventors: Uri Admon, Tel-Aviv (IL); Shay Gissin, Rishon-LeZion (IL); Dror Zlit, Ramat-Gan (IL)

Correspondence Address: Martin D. Moynihan;PRTSI, P.O. Box 16446, Arlington, VA, 22215, US

(21) Appl. No.: 12/087,070

(22) PCT Filed: Dec. 27, 2006
(86) PCT No.: PCT/IL2006/001498

§ 371 Date: Jun. 25, 2008

Related U.S. Application Data
(60) Provisional application No. 60/751,411, filed on Dec. 19, 2005.
(60) Provisional application No. 60/815,886, filed on Jun. 23, 2006.

(51) Int. Cl. G06Q 30/00; H04M 3/42; G06Q 10/00; H04W 4/24

(52) U.S. Cl. 705/7; 455/414.2; 455/405; 705/14

(57) ABSTRACT

A network adapted to distribute content to mobile phone service providers. The network comprising: (a) an acquisition module configured to receive and store content items from at least one content provider, assign a unique content identifier to each of the content items and associate each content item with a content provider rule; (b) a query module configured to receive content requests from a plurality of mobile phone service providers, each request associated with a service provider rule; and (c) a distribution module configured to compare each of the content items with the service provider rule and make available to each service provider content items in accord with the content provider rule and the service provider rule.

### FIELD OF THE INVENTION

The present invention relates to distribution of content for mobile phones.

### BACKGROUND OF THE INVENTION

Although many mobile phones are equipped to retrieve content from remote locations, they are often perceived by users as being difficult to use for searching for content. Similarly, many mobile phones are capable of having content (e.g. advertising) directed to them from remote locations but content providers have difficulty establishing distribution channels because of the large number of phone service providers.

Typically, mobile phone users download content to their phones primarily from a portal operated by a phone service provider. Users rarely go beyond direct links from the portal provided by their service provider.

Phone service providers may have varying degrees of awareness of what content items which are suitable for handsets used by their subscribers are available. As a result, the choices they present in a portal may be limited and/or static.

As is well known, for general Internet use, a single Internet address can be advertised, that any user anywhere in the world can access to obtain given content. In the telephony world however, there is no possibility of providing cellular content at a given address that is the same for all users. Consequently one cannot advertise that address for all users, as one would do for regular Internet, and the content provider ends up being very much less in control of the distribution of his content, to the benefit of the cellular provider.

Furthermore, billing for use of the content is generally via the telephone bill, which is managed by the cellular provider. The content provider may or may not receive breakdowns of how the content has been used at the whim of the cellular provider and often has no way of knowing whether he is being paid fairly or not.

### SUMMARY OF THE INVENTION

A broad aspect of some embodiments of the invention relates to providing content to mobile phone handsets. In an exemplary embodiment of the invention, a plurality of content providers deposit content on a content database server or network of servers. In an exemplary embodiment of the invention, the database is accessible using mobile phone network protocols. Exemplary mobile phone network protocols include, but are not limited to WAP and GPRS. The term mobile phone handset as used in this specification and the accompanying claims refers to cellular telephone handsets as well as to satellite telephone handsets. Optionally, a phone handset is a device with mobile telephone capabilities in addition to many other capabilities, and the present embodiments relate to download of content using telephone-based protocols.

An aspect of some embodiments of the invention relates to centralization of billing for content provided from multiple content providers to subscribers receiving service from multiple service providers. Optionally, the content is dynamic. In an exemplary embodiment of the invention, dynamic content is sold on a subscription basis. In an exemplary embodiment of the invention, billing is per download or per update.

An aspect of some embodiments of the invention relates to automated distribution of content from a content provider to subscribers receiving service from multiple service providers.

Optionally, the content includes advertising. In an exemplary embodiment of the invention, billing for distribution of an advertisement to subscribers receiving service from multiple service providers is centralized.

Optionally, the content is dynamic and subscribers pay for updates. In an exemplary embodiment of the invention, billing for distribution of dynamic content to subscribers receiving service from multiple service providers is centralized.

In an exemplary embodiment of the invention, there is provided a network adapted to distribute content to mobile phone service providers, the network comprising:
(a) an acquisition module configured to receive and store content items from at least one content provider, assign a unique content identifier to each of the content items and associate each content item with a content provider rule;
(b) a query module configured to receive content requests from a plurality of mobile phone service providers, each request associated with a service provider rule; and
(c) a distribution module configured to compare each of the content items with the service provider rule and make available to each service provider content items in accord with the content provider rule and the service provider rule.

Optionally, the network comprises a billing module configured to debit an account of a service provider and credit an account of a content provider.

Optionally, the billing module debits the account of the service provider in accord with the service provider rule.

Optionally, the billing module credits the account of the content provider in accord with the content provider rule.

Optionally, the billing module operates responsive to a notice from a service provider that a content item has been distributed to a subscriber.

Optionally, the service provider rule stipulates a price.

Optionally, the content provider rule stipulates a price.

Optionally, the content provider rule stipulates a distribution area.

Optionally, the content provider rule stipulates a number of times that the content can be distributed to subscribers to service providers.

Optionally, at least a portion of the content providers comprise advertisers and at least a portion of the content items comprise advertisements.

Optionally, the distribution module is configured to include an advertisement in a content item provided by a content provider that is not an advertiser.

Optionally, at least a portion of the content provider rules comprise campaign rules.

Optionally, the network comprises a billing module configured to debit an account of an advertiser in accord with the campaign rules.

Optionally, the at least a portion of the content providers provide dynamic content and at least a portion of the content items comprise the dynamic content.

Optionally, the service provider rules permit distribution of dynamic content to subscribers of the service provider based upon a dynamic content subscription.

Optionally, the network comprises a billing module configured to debit an account of a service provider in accord with a dynamic content subscription purchased by a subscriber to the service provider.

In an exemplary embodiment of the invention, there is provided a server adapted to distribute content to mobile phone handsets, the server comprising:
(a) an acquisition module configured to receive and store content items from a plurality of content providers, assign a unique content identifier to each of the content items and associate each content item with a content provider rule;
(b) an authorization module configured to receive a guarantee from a mobile phone service provider that the service provider will pay for any content requested by its subscribers and to designate the mobile phone service provider as an authorized service provider; and
(c) a subscriber interface configured to offer content to subscribers belonging to an authorized service provider for a fee.

Optionally, the server comprises a billing module configured to debit an account of the authorized service provider and credit an account of the content provider responsive to download of a content item supplied by the content provider by a subscriber to the authorized service provider.

Optionally, the billing module debits the account of the service provider in accord with a service provider rule.

Optionally, the billing module identifies the subscriber to the service provider.

Optionally, the billing module credits the account of the content provider in accord with the content provider rule.

Optionally, the service provider rule stipulates a price.

Optionally, the content provider rule stipulates a price.

Optionally, the content provider rule stipulates a distribution area.

Optionally, the content provider rule stipulates a number of times that the content can be distributed to subscribers.

Optionally, at least a portion of the content providers comprise advertisers and at least a portion of the content items comprise advertisements.

Optionally, the subscriber interface is configured to include an advertisement in a content item provided by a content provider that is not an advertiser.

Optionally, at least a portion of the content provider rules comprise campaign rules.

Optionally, the server comprises a billing module configured to debit an account of an advertiser in accord with the campaign rules.

Optionally, at least a portion of the content providers provide dynamic content and at least a portion of the content items comprise dynamic content.

Optionally, the service provider rules permit distribution of dynamic content to subscribers of the service provider based upon a dynamic content subscription.

Optionally, the server comprises a billing module configured to debit an account of a service provider in accord with a dynamic content subscription purchased by a subscriber to the service provider.

Optionally, the server comprises a fee determination module.

Optionally, the fee determination module is configured to determine a fee which includes a portion for payment to the content provider.

Optionally, the fee determination module is configured to determine a fee which includes a portion for payment to the mobile phone service provider.

Optionally, the fee determination module is configured to determine a fee which includes a portion for payment to an operator of the server.

Optionally, the fee determination module is configured to determine a fee which includes a portion for payment to an owner of rights to the content other than the content provider.

Optionally, the server comprises a rights compliance module configured to credit an account of the owner of rights in accord with an instruction issued by the fee determination module.

In an exemplary embodiment of the invention, there is provided an advertising server adapted to distribute advertisements to mobile phone handsets, the server comprising:
(a) an acquisition module configured to receive and store advertising content from one or more advertisers;
(b) a distribution module configured to distribute the advertising content to handsets of subscribers belonging to a plurality of mobile phone service providers.

Optionally, the distribution module distributes the advertising content in accord with a campaign rule specified by an advertiser providing the content.

Optionally, the server comprises a billing module configured to debit an account of the advertiser in accord with the campaign rules.

Optionally, the campaign rules comprise a temporal constraint on distribution of the advertising content.

Optionally, the campaign rules comprise a designation of a number of subscribers to receive the advertising content.

Optionally, the server comprises a subscriber profile data base comprising subscriber profiles of subscribers belonging to a plurality of mobile phone service providers.

Optionally, the campaign rules comprise at least one subscriber characteristic as a constraint on distribution of the advertising content.

Optionally, the server comprises a target identifier module configured to communicate at least one desired subscriber characteristic to a plurality of mobile phone service providers and to receive from the mobile phone service providers phone numbers of subscribers that comply with the desired subscriber characteristic.

Optionally, the campaign rules comprise at least one subscriber characteristic as a constraint on distribution of the advertising content.

Optionally, the server comprises a progress reporting module configured to issue a report to an advertiser on a degree of progress towards a goal defined by the campaign rule.

Optionally, the distribution module is configured to distribute interstitial advertisements.

Optionally, the distribution module is configured to distribute banner advertisements.

Optionally, the distribution module is configured to distribute advertisements comprising a phone prompt.

In an exemplary embodiment of the invention, there is provided a method of distributing mobile phone content, the method comprising:
(a) accepting a plurality of individual content items from at least one content provider and associating a content provider distribution rule with each individual content item;
(b) offering the individual content items to individual subscribers belonging to a plurality of phone service providers via their handsets in accord with the content provider distribution rule.

Optionally, the method comprises assigning a unique content identifier (UID-C) to each individual content item.

Optionally, the offering is through a mobile phone service provider.

Optionally, the offering is through a content server.

Optionally, the method comprises imposing a service provider rule as a condition for the offering.

Optionally, the method comprises imposing a content server rule as a condition for the offering.

Optionally, at least a portion of the content items comprise advertising.

Optionally, the content provider distribution rule comprises an advertising campaign rule.

Optionally, the offering is directed to a subset of the individual subscribers based upon individual subscriber profiles and at least one subscriber characteristic specified in the content provider distribution rule.

Optionally, at least some of the individual content items comprise dynamic content. Optionally, the offering comprises making a dynamic content subscription available to the subscribers belonging to the plurality of phone service providers.

Optionally, the dynamic content subscription provides notice of changes in dynamic content via the handsets of the subscriber.

Optionally, the method comprises debiting an account of a phone service provider providing service to an individual subscriber when the individual subscriber accepts a content item in the offering.

Optionally, the method comprises debiting an account of the individual subscriber for the accepted content item.

Optionally, the method comprises crediting an account of a content provider when an individual content item provided by the content provider and included in the offering is accepted by an individual subscriber.

Optionally, the method comprises crediting an account of a phone service provider providing service to an individual subscriber when the individual subscriber receives an advertisement.

Optionally, the method comprises crediting an account of the individual subscriber for the received advertisement.

Optionally, the method comprises debiting an account of a content provider providing the advertising in return for delivering the advertising to individual subscribers via their handsets.

Optionally, the method comprises debiting an account of a content provider providing the advertising when an individual subscriber responds to an advertisement delivered via their handset.

Optionally, the method comprises debiting an account of a phone service provider providing service to an individual subscriber when the individual subscriber orders a dynamic content subscription.

Optionally, the method comprises debiting the account of the individual subscriber for the dynamic content subscription.

Optionally, the method comprises crediting an account of a content provider providing the dynamic content.

### BRIEF DESCRIPTION OF THE DRAWINGS

Exemplary non-limiting embodiments of the invention described in the following description, read with reference to the figures attached hereto. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale.

The attached figures are:

FIGS. 1A and 1B are simplified flow diagrams illustrating methods for centralized content distribution and billing to mobile phone subscribers according to exemplary embodiments of the invention;

FIG. 2 is a schematic representation of an exemplary content distribution network for mobile phone subscribers according to an exemplary embodiment of the invention;

FIG. 3 is a simplified flow diagram illustrating an exemplary method for centralized advertising content distribution and billing to mobile phone subscribers according to an exemplary embodiment of the invention;

FIG. 4 is a simplified flow diagram illustrating an exemplary method for centralized advertising content distribution and billing to mobile phone subscribers according to an exemplary embodiment of the invention; and

FIG. 5 is a simplified flow diagram illustrating an exemplary method for subscriber profiling according to an exemplary embodiment of the invention;

FIG. 6 is a schematic representation of an exemplary network architecture according to an exemplary embodiment of the invention;

FIG. 7 is a schematic representation of an exemplary network architecture according to an exemplary embodiment of the invention;

FIG. 8 is a schematic representation of an exemplary network architecture according to an exemplary embodiment of the invention;

FIG. 9 is a simplified flow diagram illustrating a method for centralized content distribution and billing to mobile phone subscribers according to exemplary embodiments of the invention.

### DESCRIPTION OF EXEMPLARY EMBODIMENTS

### Overview

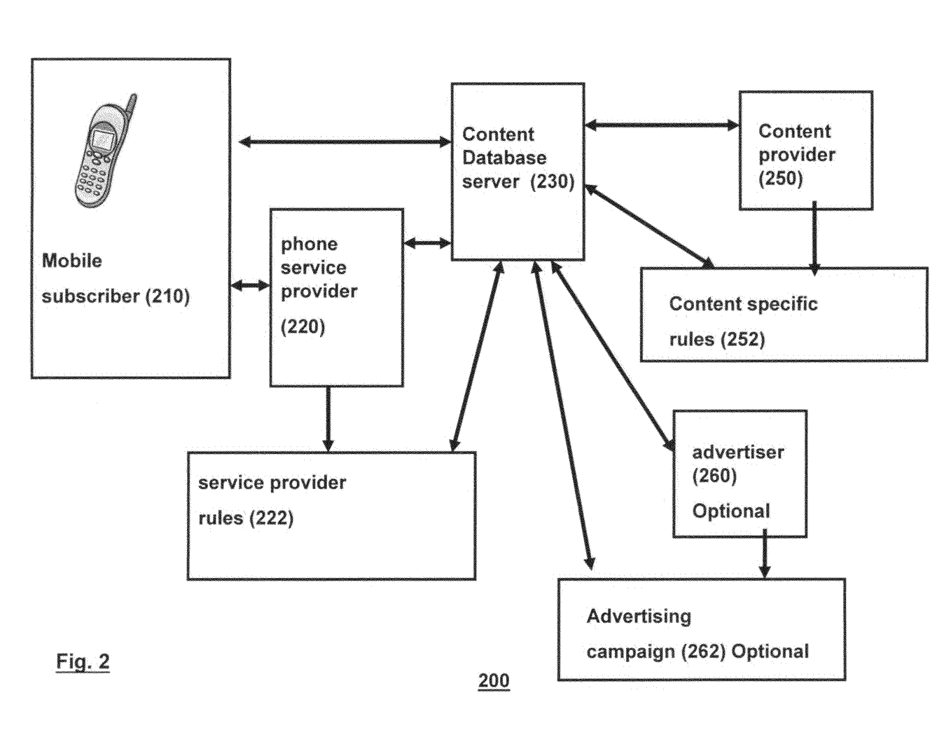

FIG. 2 is a schematic representation of an exemplary content distribution network 200 for distributing mobile phone content to mobile phone subscribers 210. In the depicted embodiment, system 200 includes a content server 230. Server 230 acts as a broker between content providers 250 and subscribers 210. Optionally, mobile phone service providers 220 act as brokers between subscribers 210 and server 230. Brokerage by server 230 can be in accord with content specific rules 252 supplied by content providers 250 and/or in accord with service provider rules 222 supplied by service providers 220. In the depicted embodiment, optional advertisers 260 provide advertising content to server 230. Optionally, server 230 considers constraints of an advertising campaign 262 when brokering between content providers 250 and subscribers 210. In an exemplary embodiment of the invention, subscribers 210 receive advertising content provided by advertisers 260 together with non-advertising content provided by content providers 250.

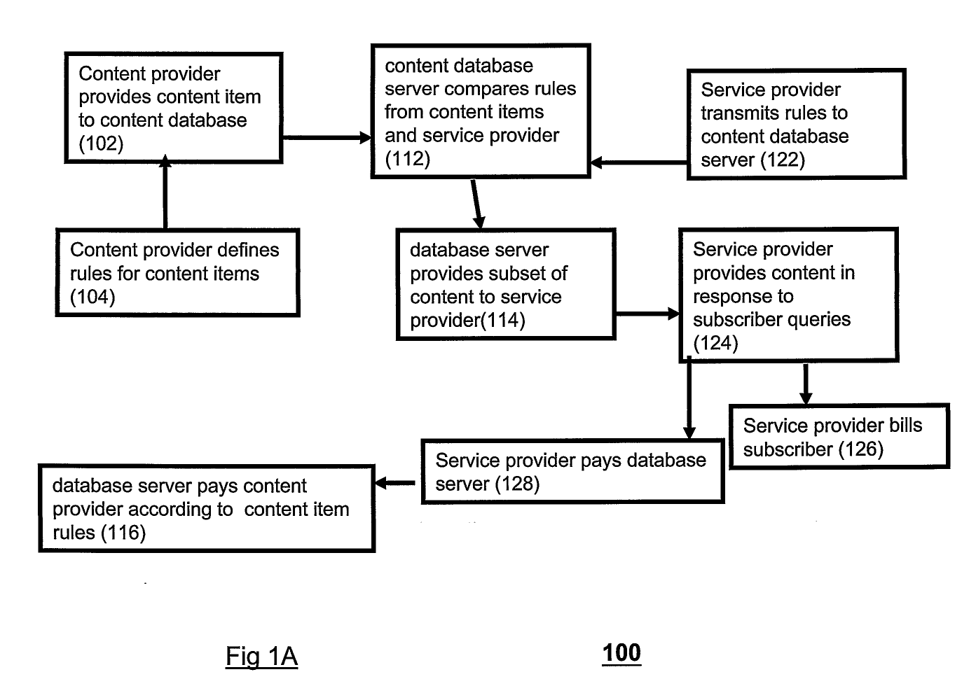

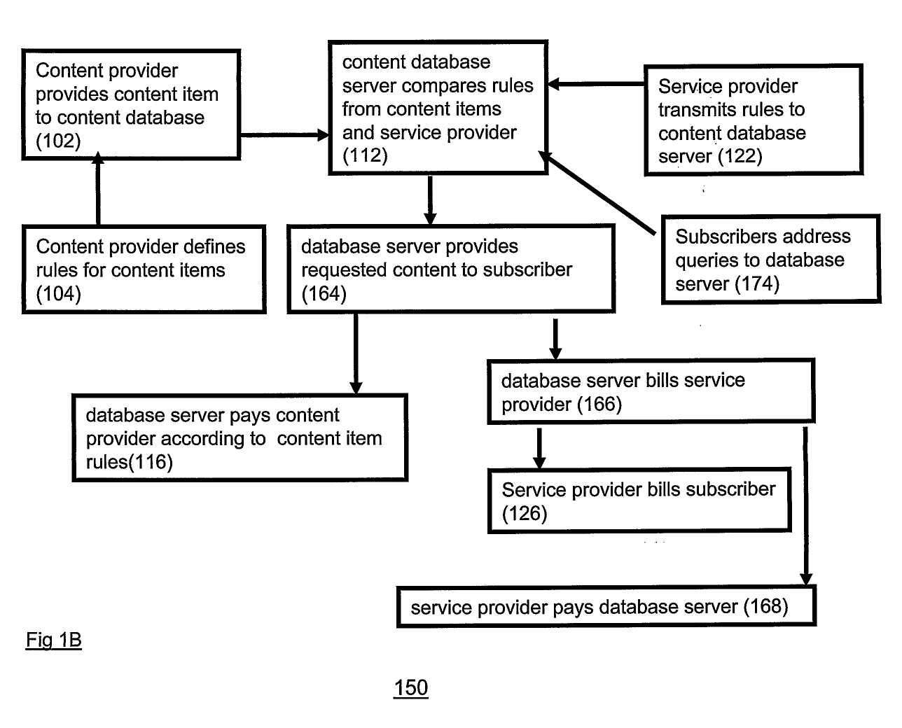

FIGS. 1A and 1B are simplified flow diagrams illustrating methods for distribution of mobile phone content which employ network 200.

FIG.1A illustrates an exemplary method 100 for distribution of mobile phone content.

At 102, a content provider provides content items to a content database.

At 104 the content provider defines rules for the content items.

At 122 a service provider transmits rules to a content database server.

At 112, the content database servers compares the rules from 122 and 104.

At 114, the database server provides a subset of content to the service provider.

At 124, the service provider provides content in response to subscriber queries. Optionally, the service provider bills 126 the subscriber.

At 128 the service provider pays the database server and at 116 the database server pays the content provider according to rules stipulated at 104.

FIG. 1B illustrates another exemplary method 150 for distribution of mobile phone content.

Method 150 is similar to method 100 at 102, 104, 112 and 122. According to depicted exemplary method 150, subscribers address queries to the database server at 174.

At 164, the database server responds by providing the requested content to the subscriber.

At 166 the database server bills the service provider and at 168 the service provider pays the database server.

As in method 100, the service provider optionally bills the subscriber at 126 and the database server pays the content provider according to rules stipulated at 104 at 116.

Network 200 and methods 100 and/or 150 distribute mobile phone content from a plurality of content providers 250 to subscribers 210 belonging to a plurality of mobile phone service providers 220 via a content server 230. Optionally, server 230 is provided as two or more servers acting in concert to perform the functions described hereinbelow.

For clarity, the figures depict a single content provider 250, a single service provider 220 and a single subscriber 210 although a larger number of each are typically present in actual exemplary embodiments of the invention.

Referring now to FIG. 2, an exemplary content distribution network 200 is described in general termns. In an exemplary embodiment of the invention, network 200 comprises a content database 230, a plurality of phone service providers 220 (only one is pictured) and a plurality of content providers 250 (only one is pictured). Each phone service provider 220 typically includes a large number of mobile phone service subscribers 210 (only one is pictured for clarity). In some exemplary embodiments of the invention, one or more advertisers 260 provide advertising content.

For purposes of this specification and the accompanying claims, the term “content” includes, but is not limited to, static graphics (e.g. wallpapers), animation, video, sound (e.g. music files), ringtones, text, programs, screen savers and games formatted for presentation on a mobile phone handest. Optionally, the content includes advertising. Suitable file formats for content presentation include, but are not limited to: jpeg, mpeg, tiff, MP3, MP4, AAV, JAVA, MMS and SMS.

In some exemplary embodiments of the invention, content is dynamic. Optionally, subscribers 210 order dynamic content subscriptions and receive updates.

According to exemplary content distribution method 100, content providers 250 provide 102 content items to content database 230. Optionally, content providers 250 define rules 104 for distribution of the provided content items.

In an exemplary embodiment of the invention, rules 104 defined by content provider 250 can include one or more of a price (e.g. a minimum price and/or a maximum price), a number of times the item can be distributed (e.g. a minimum and/or a maximum number of copies) and a permitted distribution area (e.g. a list of countries).

In an exemplary embodiment of the invention, server 230 assigns each content item provided by content providers a unique content identifier (UID-C). UID-C is subsequently used in tracking distribution of content and/or in billing service providers 220 and/or in billing subscribers 210 and/or in payment to content providers 250.

In an exemplary embodiment of the invention, service providers 220 transmit service provider rules 122 to server 230. Rules 122 defined by service provider 220 can include one or more of a price (e.g. a minimum price and/or a maximum price), a content type restriction (e.g. no adult content or only content in a specified language), a content size restriction and a hardware compatibility restriction (e.g. only content items compatible with handsets supplied by the service provider to its subscribers).

According to various exemplary embodiments of the invention, rules 104 and/or 122 can be defined in inclusive terms, exclusive terms or absolute terms.

According to exemplary method 100, server 230 compares 112 rules 104 from content providers 250 and rules 122 from service providers 220 to determine a subset of content items which satisfy both sets of rules. Optionally, server 230 implements its own additional rules (e.g. minimum profit criteria and/or minimum periodic payment). According to exemplary method 100, the subset of content items is provided 114 to service provider 250. In an exemplary embodiment of the invention, service provider 250 provides 124 content from the subset of content items in response to subscriber queries. Optionally, service provider 250 operates a subscriber query interface accessible to subscribers 210. In an exemplary embodiment of the invention, the subscriber query interface is accessible to subscribers 210 from their phone handsets.

In the depicted exemplary embodiment, service provider 250 bills 126 subscriber 210 for each downloaded content item. Optionally, downloaded content items appear on a periodic mobile phone service bill issued to subscriber 210 by service provider 250. In the depicted exemplary embodiment, service provider 250 transmits payment 128 to server 230 according to rules 104 and/or 122 and/or additional rules imposed by server 230. According to exemplary method 100, server 230 transmits payment 116 to content provider 250 according to rules 104.

In an exemplary embodiment of the invention, an operator of server 230 is motivated by profit. For example if a specific content item in the form of a ringtone provided by content provider 250 is defined by rule 104 which specifies “minimum price 15 cents; maximum price 35 cents” and a service provider 220 has defined a rule 122 which says “provide ringtones for twenty five cents or less to be resold to subscribers at thirty-five cents”, database 230 can provide the ringtone to service provider 220 for twenty-five cents, pay content provider 250 fifteen cents and realize a ten cent profit.

In an exemplary embodiment of the invention, server 230 is transparent with respect to subscribers 210 of service providers 220. Optionally, subscribers 210 accustomed to downloading content from a server operated by service provider 220 are unaware that server 230 exists. According to method 100, subscribers 210 continue to interact with a subscriber query interface provided by their service provider 220. According to method 150, subscribers 210 interact with server 230. Optionally, their service provider 220 routes them to server 230 and they are unaware that server 230 is not operated by their service provider.

In an exemplary embodiment of the invention, a subscriber's telephone number identifies subscriber 210 and/or service provider 220 to server 230. According to this exemplary embodiment of the invention the phone number serves as both a unique subscriber identification (UID-S) and a unique service provider identification (UIS-SP)

In an exemplary embodiment of the invention, a subscriber's telephone number identifies subscriber 210 to service provider 220 (i.e. UID-S).

Optionally, server 230 stores a lookup table of phone numbers for subscribers 210 and service providers 220 and implements billing according to the lookup table.

FIG. 1B illustrates an exemplary method 150 in which subscribers 210 communicate directly with server 230 from their mobile handsets. In the depicted embodiment, many of the actions are similar to those performed in method 100. These similar actions are identified with reference numerals identical to those used in FIG. 1A and are as described above.

Method 150 differs from method 100 primarily in that subscribers 210 address queries 174 to database server 230. As in method 150, server 230 identifies content which meets the criteria of rules 104 and 122 and presents a subset of all available content in a subscriber interface. Subscriber 210 requests one or more content items using the subscriber interface and server 230 provides 164 requested content to subscriber 210.

In an exemplary embodiment of the invention, database server 230 bills 166 service provider 220 for content items provided to subscriber 210 and service provider 220 pays 168 server 230. Optionally, service provider 220 bills 128 subscriber 210 for the requested content. As in method 100, database server 230 pays 116 content provider 250 according to content item rules 104.

For content providers 250, use of server 230 optionally contributes to an increased ability to distribute content to subscribers 210 belonging to multiple service providers 220. In an exemplary embodiment of the invention, content providers 250 establish a business relationship only with an operator of server 230 service providers 220. In an exemplary embodiment of the invention, server 230 guarantees payment for content distributed to subscribers 210 according to rules 252.

For service providers 220, use of server 230 optionally contributes to an increased ability to provide content to subscribers 210. In an exemplary embodiment of the invention, service providers 220 establish a business relationship only with an operator of server 230 and not with service providers 220. Optionally, use of server 230 reduces a need for service providers 220 to negotiate distribution contracts with individual content providers 250. In an exemplary embodiment of the invention, server 230 supplies content to subscribers 210 of service provider 220 according to rules 222.

For an operator of server 230, differences between content specific rules 252 and service provider rules 222 provide an opportunity for profit. Server 230 optionally institutes additional rules to insure an acceptable level of profit when supplying content from content providers 250 to subscribers 210 of service provides 220.

For subscribers 210, use of server 230 optionally contributes to an increased availability of content from a wider range of content providers 250. In an exemplary embodiment of the invention, subscribers 210 establish a business relationship only with their own service provider 220. Optionally, use of server 230 reduces a need for subscribers 210 to locate and/or identify individual content providers 250. Optionally, subscriber's 210 are unaware of the existence of server 230. In an exemplary embodiment of the invention, subscriber 210 is billed for content downloads on a bill received from service provider 220. Optionally, service provider 220 offers content “packages” to subscribers 210. In an exemplary embodiment of the invention, the packages are provided for a fee. Alternatively or additionally, packages may be offered as an incentive or reward, with service provider 220 assuming responsibility for payment to server 230 for content items in the package.

For example, a service provider 220 might offer a subscriber 210 a “start-up” package as a reward for purchase of a new handset. The “start-up” package might include, for example, ringtones, wallpapers, games and video clips. Optionally, the amount one or more types of content in the “start-up” package increases with the purchase price of the new handset. In an exemplary embodiment of the invention, items offered in a “start-up” package serve as venues for advertising distribution.

Alternatively or additionally, a service provider 220 might offer a subscriber 210 a “use bonus” package as a reward for exceeding a threshold of airtime.

Optionally, the amount one or more types of content in the “use bonus” package increases with the amount of air-time billed to subscriber 210. In an exemplary embodiment of the invention, items offered in a “use bonus” package serve as venues for advertising distribution.

In an exemplary embodiment of the invention, subscribers 210 provide billing information (e.g. credit card details) only to their service provider 220. Optionally, concealing subscriber billing information from content providers 250 and/or server operator 230 contributes to a reduction in risk of unauthorized account use for subscribers 210. 25 According to some exemplary embodiments of the invention, (e.g. FIG. 1B) subscribers 210 communicate directly with server 230 and service provider 220 is involved primarily in billing subscriber 210 and paying server 230. According to other exemplary embodiments of the invention, (e.g. FIG. 1A) subscribers 210 still select content from an interface provided by service provider 220. In either case, server 230 30 handles transfer of funds from service providers 220 to content providers 250. In either case, service provider 220 assumes responsibility for collecting money from subscriber 210 for delivered content.

### Exemplary Content Organization Formats

Whether subscriber communicates directly with server 230 as in method 150, or views content through an interface provided by service provider 220, the available content can be presented in a variety of organizational hierarchies. Organizational hierarchies include, but are not limited to:
Content type>(Handset type) >Theme>individual content items
Theme>Content type>(Handset type) >individual content items
(Handset type)>Content type>Theme>individual content items
Content type>Theme>individual content items>(Handset type)

Exemplary content types include, but are not limited to, ringtones, wallpapers, games, text (e.g. SMS messages and/or dynamic content updates), animation and video.

Exemplary themes include, but are not limited to, sports, entertainment, adult content, nature, seasonal and professional. Optionally, themes are divided into sub-themes (e.g. seasonal can be divided into Christmas, Hanukkah, Valentine's day, Easter, Passover, Spring Break, July Fourth, Halloween and Thanksgiving)

In an exemplary embodiment of the invention, the individual content items are the actual units of distribution.

Optionally server 230 and/or an interface provided by service provider 220 is aware of a handset type of subscriber 210 browsing for and/or downloading content. In an exemplary embodiment of the invention, server 230 is configured to automatically provide a correct version for a handset operated by subscriber 210 when a specific content item is ordered. Differences in format for a single content item may arise, for example from differences on operating system and/or preferred file format and/or resolution and/or hardware configuration between different handset manufacturers and/or different models from a manufacturer. Optionally, a handset used by subscriber 210 to communicate a search query identifies itself to the search interface in terms of manufacturer and/or model number. Optionally, the identification is by a signal sent from the handset to the interface as part of the search query. Alternatively or additionally, the search interface has access to a table of handset manufacturer/model by phone number. In an exemplary embodiment of the invention, the interface identifies a handset type belonging to subscriber 210 and offers and/or provides only content items in a suitable format for the identified handset.

In some preferred embodiments of the invention, subscriber 210 actively notifies the interface of handset manufacturer/model. Optionally, notification of handset manufacturer/model is during a first use by a specific subscriber 210 and the interface identifies the specific subscriber 210 by phone number during subsequent usage. Optionally, the interface constructs a table of handset manufacturer/model by phone number using information actively provided by specific subscribers.

In some preferred embodiments of the invention, subscriber 210 indicates a handset manufacturer/model in each session with the interface and the subscriber is offered only compatible content for the designated handset manufacturer/model, In some preferred embodiments of the invention, subscriber 210 indicates a handset manufacturer/model in each download request and a compatible version of the content for the designated handset manufacturer/model is downloaded,

### Exemplary Content Providers

Commercial concerns

In some exemplary embodiments of the invention, content providers 250 include commercial concerns. Theoretically, commercial concerns could establish business relationships with multiple service providers 220 and/or operate a user interface for direct access by subscribers 210 belonging to multiple service providers 220 for the purpose of content distribution. However, existing mobile phone user interfaces (e.g. WAP and/or GPRS) are not sufficiently user friendly that subscribers 210 easily find content distribution sites not provided by provider 220. From the standpoint of the commercial concern, use of server 230 as a marketing intermediary contributes to expedited distribution and/or reduced risk in collecting charges from subscribers 210 and/or simplified accounting resulting from not having to establish accounts with multiple service providers 220.

In an exemplary embodiment of the invention, a content provider 250 in the form of a record company record company can prepare ringtones from hit songs and sell them to the server 230 for distribution to subscribers 210 using specified business rules. Optionally, the rules in this case include a financial incentive for rapid distribution. In this way, rapid ringtone distribution can serve as a promotional tool and/or contribute t increased revenue from a ringtone while a song is still “on the charts”.

Service providers as content providers In some exemplary embodiments of the invention, service providers 220 can also function as content providers 250. Prior to the present invention, many service providers 220 provided content directly to their own subscribers 210, but not to subscribers 210 of other service providers 220. In some cases, a service provider 220 prepared the content or otherwise acquired exclusive distribution rights. In an exemplary embodiment of the invention, a service provider 220 takes advantage of an existing business relationship with server 230 to distribute content in which they have rights to subscribers 210 of other service providers 220. In this way, service provider 220 becomes a content provider. In an exemplary embodiment of the invention, a service provider 220 does not establish a direct business relationship with other service providers 220 and/or their subscribers 220 while serving as their content provider 250.

### Independent Professionals as Content Providers

In an exemplary embodiment of the invention, independent professionals (e.g. artists; musicians; programmers) can function as content providers 250. Optionally, use of server 230 as an intermediary spares the independent professionals from establishing a business relationship with multiple service providers 220. In an exemplary embodiment of the invention, server 230 contributes to a reduction in distribution complexity for a small independent professional wishing to act as a content provider.

### Individuals as Content Providers

In an exemplary embodiment of the invention, individuals (e.g. amateur photographers, amateur cartoonists or amateur artists) can function as content providers 250. Optionally, use of server 230 as an intermediary spares the individual from establishing a business relationship with multiple service providers 220. In an exemplary embodiment of the invention, server 230 contributes to a reduction in distribution complexity for a small independent professional wishing to act as a content provider. Optionally, the individual is a subscriber 210 of a service provider 220. In an exemplary embodiment of the invention, the service provider 220 serves as a broker between the individual subscriber 210 and server 230. In an exemplary embodiment of the invention, the service provider realizes a brokerage fee.

Exemplary communication interfaces Server 230 has been described primarily in terms of its ability to distribute content to handsets belonging to subscribers 210 via available mobile phone communication protocols (e.g. WAP and GPRS). In an exemplary embodiment of the invention, server 230 can also communicate via non-telephone communication protocols.

Optionally, a non-telephone interface is employed for one or more of upload of content to server 230 from content providers, billing of service providers 220, payment to content providers 250, reporting to subscribers 210, billing of advertisers 260 and reporting to advertisers 260.

In an exemplary embodiment of the invention, content providers 250 in the form of independent professionals and/or individuals upload content to server 230 for distribution using a user interface established for uploads. Optionally, the interface is a WWW interface. In an exemplary embodiment of the invention, the interface is also used to establish content specific rules 252. Optionally, server 230 suggests rules 252 to content providers 250 and providers 250 may either accept or reject the suggested distribution rules.

### Exemplary Business Rules

According to exemplary embodiments of the invention, content provider 250 and/or service provider 220 can each stipulate (104 and 122 respectively) one or more of price, distribution restrictions (e.g. only to subscribers above 18 years of age or only in the United States).

In an exemplary embodiment of the invention, content provider 250 can stipulate a minimum or maximum number of content units to sell. (e.g. “limited edition” content item with a total distribution of 10,000 copies). Optionally, content items can be sold to service providers in “lots” of a specified minimum size. In an exemplary embodiment of the invention, distribution of content in lots encourages service providers 220 to distribute content “packages” (e.g. as described above).

In an exemplary embodiment of the invention, a price of a content item is not necessarily uniform. For example, a content provider can offer discount on all units over a threshold. Optionally, thresholds can be established between one or more of content provider 250 and database 230, database 230 and an individual service provider 220, and content provider 250 and individual service provider 220.

Optionally, content items can be grouped for purposes of business rules. Optionally, grouping can be by content type, theme, or content item. For example, content provider 250 might stipulate a rule 252 obligating server 230 to distribute one million ringtones in a year for twenty five cents each with the stipulation that the service provider deliver 200 new ringtones every month with each ringtone to be provided in formats suitable for handsets produced by four leading manufacturers. Optionally, service provider might be obligated to always make available at least 10 of the current “Top 40” as ringtones. In this example, server 230 does not contract to distribute a particular number of any specific content item. Instead, a large number of content items supplied by content provider 250 are handled as a group for contractual purposes.

In an exemplary embodiment of the invention, rules imposed by content provider 250 and/or server 230 and/or service provider 220 can stipulate who pays applicable copyright and/or license fees and to what party payments are made. Optionally, copyright and/or license fees are paid by server 230. Optionally, payment of copyright and/or license fees by server 230 contributes to a reduction in liability for an operator of the server.

### Exemplary Advertising Distribution Method

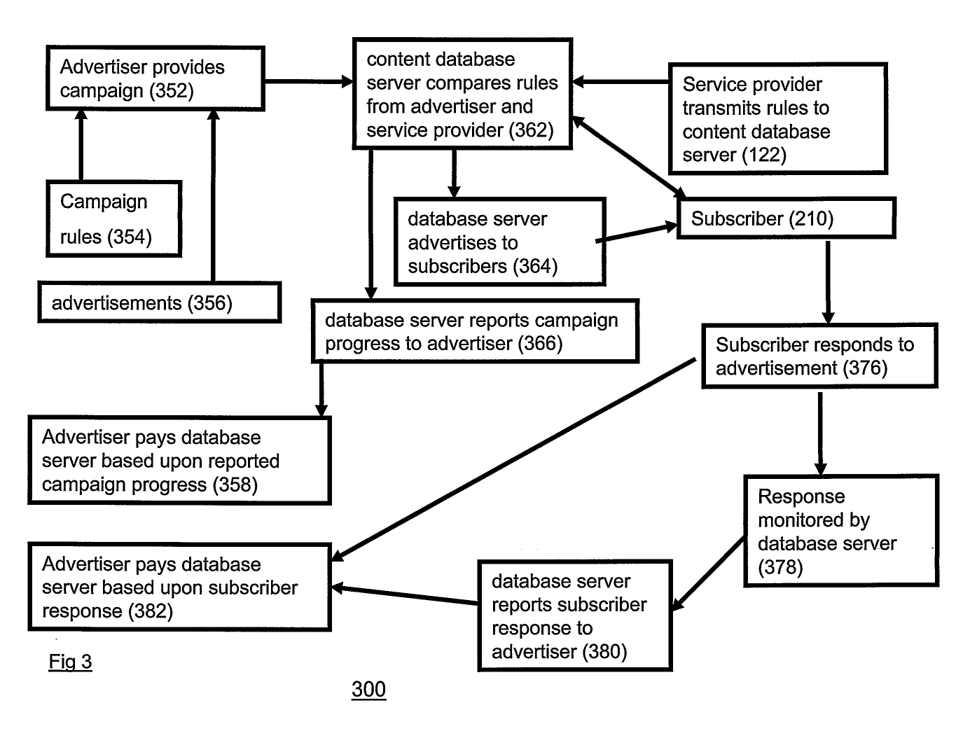

FIG. 3 illustrates an exemplary advertising method 300. In an exemplary embodiment of the invention, method 300 is implemented in the context of a network 200 (FIG. 2) and/or methods 100 and/or 150 as described hereinabove.

In the depicted embodiment of method 300, service provider 220 transmits 122 service provider rules 222 to server 230. Optionally, rules 222 describe how advertisements can be delivered to subscribers 210 of service provider 220. According to various exemplary rules 222, service provider 220 may collect a fee for each advertisement delivered to subscriber 210 and/or subscriber 210 may receive a premium (e.g. discount, credit or intangible reward) for each advertisement delivered to them. Intangible rewards include, but are not limited to “points”. Optionally, points may be redeemable during future content downloads and/or during other purchases. In some embodiments of the invention, rules 222 stipulate that content with embedded advertising is provided at a discount.

In the depicted embodiment of method 300, an advertiser 260 provides 352 a campaign 262 comprising campaign rules 354 and one or more advertisements 356. Optionally, campaign rules 354 include one or more of a number of advertisements to be distributed, a geographic distribution limit (e.g. only in certain countries and/or in certain cities), one or more temporal constraints (e.g. dates and/or time of day) and one or more demographic definitions.

Optionally, advertisements 356 are each the subject of separate rules. For example, a single campaign can comprise a temporal series of advertisements 356 to be delivered sequentially. Alternatively or additionally, advertisements 356 can be similar in content but tailored to fit different demographs. For example, a pair of advertisements for cough syrup may have a same script but feature, respectively, a male subject and a female subject reaching for the advertised product and exhibiting signs of relief after taking the advertised product.

In an exemplary embodiment of the invention, some advertisements 356 are specifically targeted to subscribers 210 visiting in a certain geographic area. This optional distribution strategy can be useful, for example, in advertising restaurants, tourist venues and hotel accommodations.

According to various exemplary embodiments of the invention, advertisements 356 can be formatted as one or more of interstitial advertisements, banner advertisements and phone prompt advertisements.

For purposes of this specification and the accompanying claims an “interstitial” advertisement is an advertisement presented before non-advertising content is presented.

For purposes of this specification and the accompanying claims a “banner” advertisement is an advertisement presented concurrently with non-advertising content. Optionally, banners include links to other content. In an exemplary embodiment of the invention, the links are formatted in a mobile phone compatible protocol (e.g. WAP or GPRS).

For purposes of this specification and the accompanying claims a “phone-prompt” advertisement is an advertisement including a suggestion to call a phone number. Optionally, the phone number is provided so that a single input from the handset causes the number to be dialed.

In an exemplary embodiment of the invention, advertisements 356 are embedded in non-advertising content. Optionally, inclusion of embedded advertising in non-advertising contributes to a reduction in cost to subscriber 210 and/or an increase in revenue for one or more of service provider 220, content provider 250 and server 230.

One example of embedded advertising is inclusion of a video advertisement in (e.g. at the beginning) of a downloaded video clip.

Another example of embedded advertising is inclusion of advertising graphics and/or sound in a downloaded game so that a player is exposed to the advertising during play.

Advertiser 260 enjoys benefits similar to those of other content providers 250. In an exemplary embodiment of the invention, advertiser 260 engages server 230 to act as a broker to implement campaign rules 354. Advertiser 260 benefits from existing business relationships between server 230 and service providers 200 and/or content providers 250. In an exemplary embodiment of the invention, use of server 230 as an intermediary contributes to a reduction in complexity of distribution of advertisements 356 to subscribers 210 of multiple service providers 220 from the standpoint of advertiser 260.

In an exemplary embodiment of the invention, communication between server 230 and advertiser 260 is via a conventional computer network (e.g. Internet) and is therefore more robust than links between server 230 and subscribers 210 which are via mobile phone network. Optionally, server 230 stores campaign 262 in a local memory.

In an exemplary embodiment of the invention, once campaign rules 354 and service provider rules 252 have been established, server 230 compares 362 the rules and locates advertising possibilities among subscribers 210 to whom advertising is permitted according to both sets of rules.

In an exemplary embodiment of the invention, server 230 then advertises 364 to subscribers 210. In an exemplary embodiment of the invention, server 230 reports 366 progress of campaign 262 to advertiser 260 periodically. Optionally, the reports comprise a bill to advertiser 260. In an exemplary embodiment of the invention, advertiser 260 pays 358 server 230 based upon reported progress of campaign 262.

In an exemplary embodiment of the invention, advertisements 356 include opportunities for subscriber 210 to respond. Optionally, subscriber 210 responds 376 to advertisement 356. Optionally, the response is directly to advertiser 262 who pays 382 server 230 for the response. Optionally, the response is monitored 378 by server 230 and reported 380 to advertiser 260. Optionally, the report comprises a bill. In an exemplary embodiment of the invention, advertiser 262 pays 382 server 230 for the response.

In some exemplary embodiments server 230 also pays service providers 220 for progress of campaign 262 attributable to their subscribers 210 and/or for access to their subscribers as potential advertising recipients.

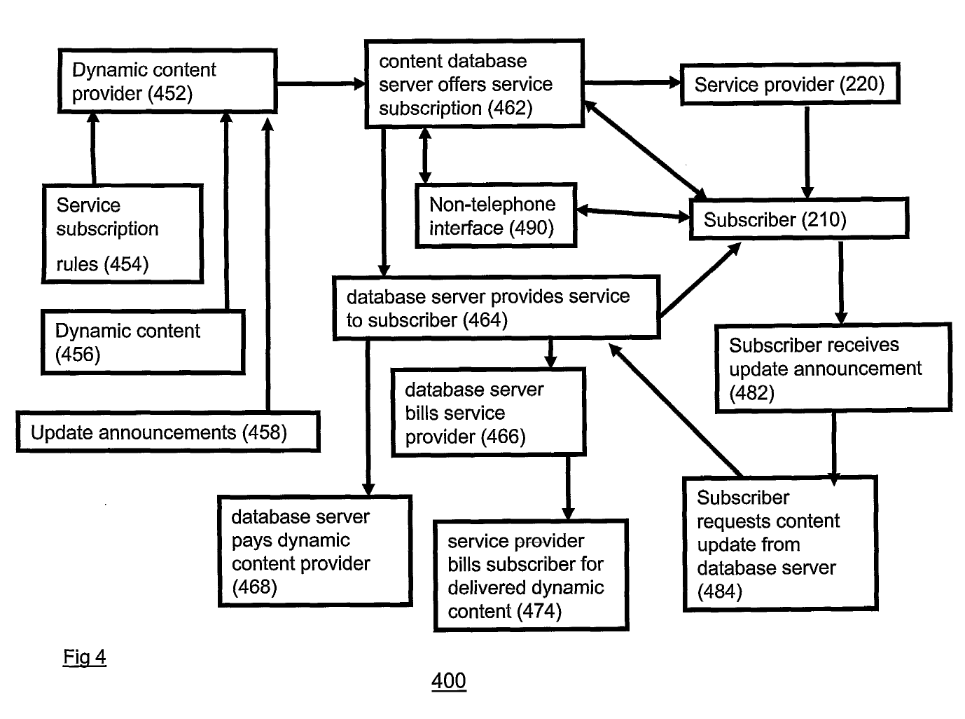

Exemplary dynamic content distribution method FIG. 4 illustrates an exemplary dynamic content delivery method 400. In an exemplary embodiment of the invention, method 400 is implemented in the context of a network 200 (FIG. 2) and/or methods 100 and/or 150 and/or 300 as described hereinabove.

In the depicted embodiment of method 400, server 230 relays offers 462 of service subscriptions 454 to dynamic content 456 to subscribers 210. In an exemplary embodiment of the invention, the subscriptions are offered by a plurality of dynamic content providers 452 (only one is pictured for clarity) according to subscription rules 454. Offers 462 of service subscriptions 454 to dynamic content 456 can be delivered to subscriber 210 via service provider 220 to a mobile phone handset and/or delivered via a non-telephone interface.

In an exemplary embodiment of the invention, a WWW page serves as an exemplary non-telephone interface. In an exemplary embodiment of the invention, server 230 operates a WWW site describing available dynamic content 456 and/or subscription rules 454.

In an exemplary embodiment of the invention, a print media advertisement which offers a subscription to dynamic content 456 service by sending an SMS with specified text to an indicated phone number serves as an exemplary non-telephone interface. Optionally, the SMS is received by server 230 which implements the subscription according to rules 454.

In an exemplary embodiment of the invention, even when using a non-telephone interface 490 to order dynamic content 456, subscriber 210 is identified only by phone number. The phone numbers serves as a UID-S and UID-SP to facilitate subsequent billing for dynamic content 456.

Once subscriber 210 has ordered dynamic content 456 according to rules 454, content 456 is provided 464 by server 230 to subscriber 210 either directly or through service provider 220. Optionally, dynamic content 456 includes advertising content (e.g. embedded advertising) provided by an advertiser 260 as part of an advertising campaign 262 as described above. Optionally, dynamic content 456 is delivered as an SMS or MMS message. In an exemplary embodiment of the invention, server 230 bills 466 service provider 220 for dynamic content 456 provided to subscriber 210. Optionally, service provider 220 bills 474 subscriber 210 for delivered dynamic content. In an exemplary embodiment of the invention, server 230 pays 468 dynamic content provider 452 for dynamic content 456 provided to subscriber 210.

In some exemplary embodiments of the invention, rules 454 stipulate that subscriber 210 has a right to refuse future updates. Optionally, part of service provision 464 from server 230 is providing update announcements 458 to subscribers 210. According to these exemplary embodiments of the invention, subscriber 210 receives 482 announcements 458 and must request 484 each content update from server 230 before the update is provided 464. Optionally, refusal of an update means that no billing for that update will occur and/or that the subscription is cancelled.

In an exemplary embodiment of the invention, dynamic content providers 452 provide dynamic content to server 230 as an RSS feed.

Exemplary dynamic content 456 suitable for distribution according to method 400 includes, but is not limited to, a notice if the price of an item changes by more than a specified amount or reaches a specified price (e.g. items could be stock shares or airfares between designated locations) and updates on score changes in selected sporting events (e.g. World Cup matches or Olympic sports).

As with other exemplary embodiments of the invention described above, use of server 230 as an intermediary for distribution of dynamic content 456 spares dynamic content provider 452 from establishing business relationships with multiple service providers 220 and/or subscribers 210.

Alternatively or additionally, subscribers 210 do not need to provide billing information to parties other than their service provider 220 in order to receive dynamic content 456 provided by dynamic content providers 452 and/or server 230.

Alternatively or additionally, service provider 220 and/or server 230 serve as intermediaries in collecting payment from subscribers 210 for dynamic content provider 452.

Exemplary Subscriber Profiling Method

In some exemplary embodiments of the invention (e.g. method 300) it is optionally useful for server 230 to divide subscribers 210 according to one or more demographic criteria.

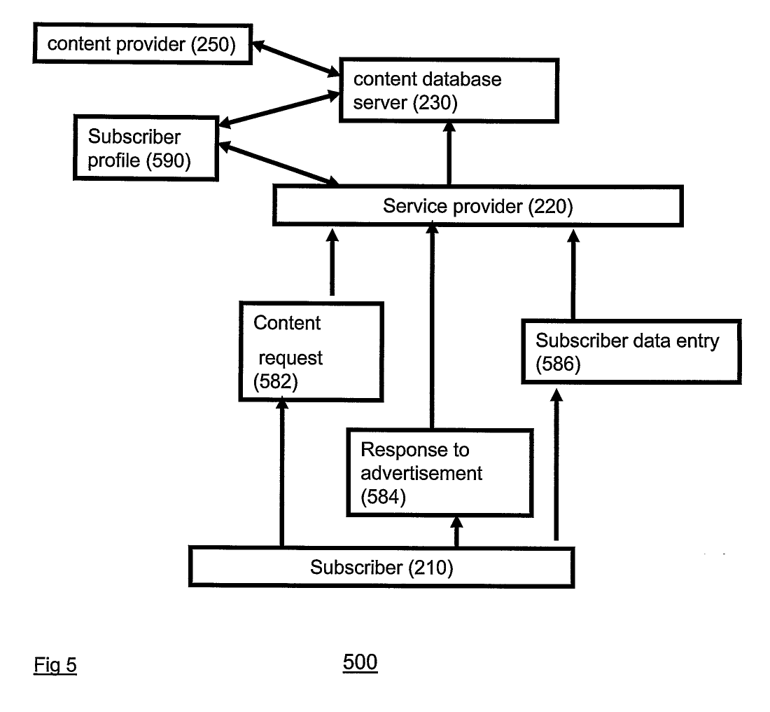

FIG. 5 illustrates an exemplary method 500 of compiling subscriber profiles 590 for subscribers 210 according to some embodiments of the invention.

Optionally, each subscriber 210 is provided an opportunity for data entry 586. The opportunity may be provided, for example, when subscriber 210 initially orders service from service provider 220 or when visiting a WWW site operated by service provider 220 and/or server operator 230. Optionally, data entry 586 is conducted via a mobile phone handset.

Optionally, the entered data is used by service provider 220 and/or server 230 to generate a subscriber profile 590. Profile 590 optionally includes one or more demographic indicators such as age, race, income level, hobbies, educational level, marital status, gender, number of children, current location (as determined by a mobile phone system in communication with a handset) and place of residence coupled to a phone number of a mobile phone handset used by subscriber 210 in conjunction with service provided by service provider 220.

In an exemplary embodiment of the invention, service provider 220 has access to profiles 590 of its own subscribers 210 while server 230 has access to profiles 590 of subscribers 210 from many service providers 220.

As subscribers 210 make content requests 582 and/or respond 584 to advertisements 356, the requests and/or responses are used to update profile 590.

In an exemplary embodiment of the invention, content providers 250, including advertisers 260, have no direct access to profiles 590. Optionally, content providers 250, including advertisers 260, purchase access to a subset of subscribers 210 having one or more desired demographic characteristics through server 230. In an exemplary embodiment of the invention, server 230 has access to a larger number of profiles 590 than any individual service provider 220. Optionally, use of server 230 as a distribution intermediary increases distribution efficiency for content providers 250, especially advertisers 260, that wish to deliver content to subscribers 210 meeting one or more demographic criteria.

In an exemplary embodiment of the invention, profiling of activities conducted in a mobile phone network increases efficiency of targeted content distribution in the mobile phone network.

Exemplary System Architectures

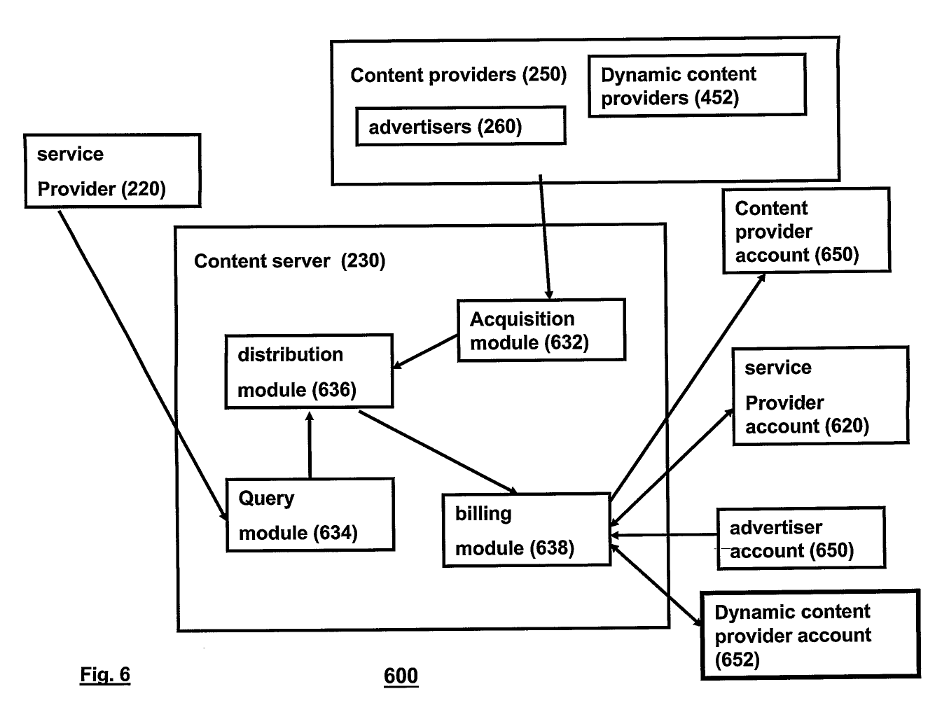

FIGS. 6, 7 and 8 schematically illustrate system architectures according to exemplary embodiments of the invention.

FIG. 6 illustrates an exemplary system architecture 600 for a network adapted to distribute mobile phone content to mobile phone service providers 220 in which server 230 comprises an acquisition module 232, a distribution module 636 , a query module 634 and a billing module 638.

In the depicted embodiment, acquisition module 632 is configured to receive and store content items from at least one content provider 250. Acquisition module 632, assigns a unique content identifier (UID-C) to each of the content items and associates each content item with a content provider rule 252.

In the depicted embodiment, query module 634 is configured to receive content requests from a plurality of mobile phone service providers 220, each request associated with a service provider rule 222.

In the depicted embodiment, distribution module 636 is configured to compare each of the content items with service provider rule 222 and make available to each service provider 220 content items in accord with the content provider rule 252 and the service provider rule 222.

Optionally, server 230 includes a billing module 638. In an exemplary embodiment of the invention, billing module 638 is configured to debit an account 620 of a service provider 220 and credit an account 650 of content provider 650. Optionally, debiting and/or crediting occur when a service provider 220 and/or a subscriber 210 is provided with a content item. Optionally, billing module 638 debits account 620 in accord with service provider rule 222 and/or credits account 650 in accord with content provider rule 252. In an exemplary embodiment of the invention, billing module 638 operates responsive to a notice from service provider 220 that a content item has been distributed to a subscriber 220. In the depicted embodiment, the notice is routed through query module 634 and distribution module 636.

As illustrated, content providers 250 can optionally include advertisers 260 and/or dynamic content providers 452.

Optionally, at least a portion of the content items comprise advertisements. In an exemplary embodiment of the invention, distribution module 636 is configured to include an advertisement 356 in a content item provided by a content provider 250 that is not an advertiser 260. Optionally, advertisers 260 provide content comprising advertisements 356 and campaign rules 354 to govern their distribution as described above.

In the depicted embodiment, billing module 638 is configured to debit an account 650 of advertiser 260 in accord with campaign rules 354.

In an exemplary embodiment of the invention, at least a portion of the content items comprise dynamic content 456. Optionally, service provider rules 222 permit distribution of dynamic content 456 to subscribers 210 of service provider 220 based upon a dynamic content subscription 454. In an exemplary embodiment of the invention, billing module 638 is configured to debit an account 620 of a service provider in accord with a dynamic content subscription 454 purchased by subscriber 210 to service provider 220.

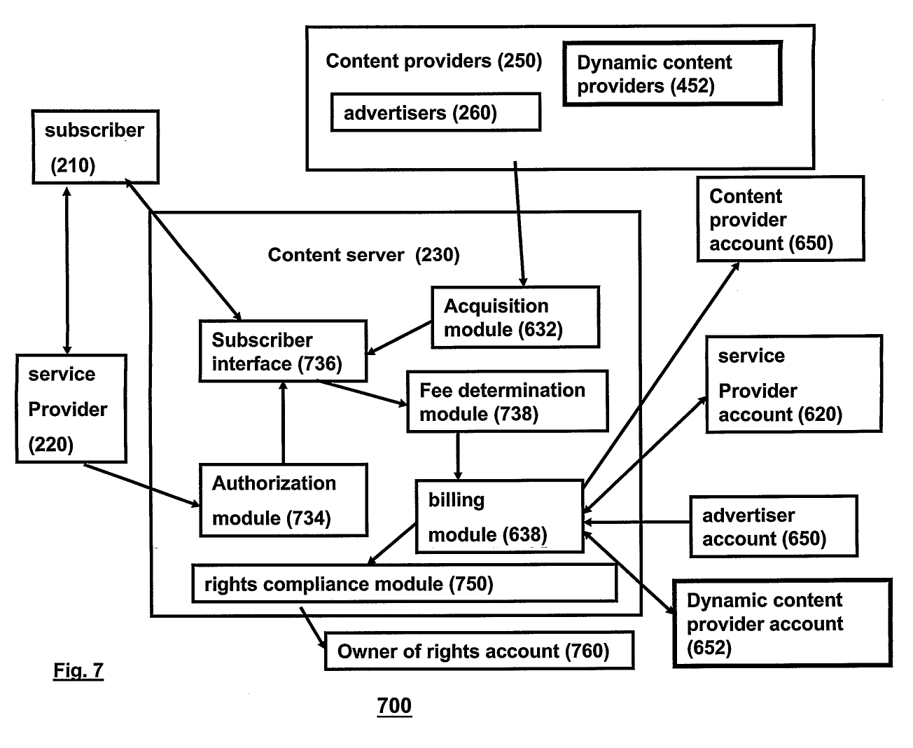

FIG. 7 illustrates another exemplary system architecture 700 for a network adapted to distribute mobile phone content directly to mobile phone subscribers 210 through their handsets. In the depicted embodiment, server 230 comprises an acquisition module 632, a subscriber interface 736, a fee determination module 738 a billing module 638, an authorization module 734 and a rights compliance module 750.

Optionally, acquisition module 632 is as described above.

In an exemplary embodiment of the invention, authorization module 734 is configured to receive a guarantee from mobile phone service provider 220 that the service provider will pay for any content requested by its subscribers 210. In return for this guarantee, authorization module 734 designates mobile phone service provider 220 as an authorized service provider.

In an exemplary embodiment of the invention, subscriber interface 736 is configured to offer content to subscribers 210 belonging to an authorized service provider 220 for a fee. Optionally, service provider 220 implements an additional authorization procedure for individual subscribers 210. In an exemplary embodiment of the invention, authorization module 734 may authorize only some subscribers 210 of an authorized service provider 220.

In an exemplary embodiment of the invention, server 230 comprises a billing module 638 with all of the capabilities described hereinabove in the context of exemplary architecture 600 and additional capabilities as described below.

In an exemplary embodiment of the invention, billing module 638 identifies subscriber 210 to service provider 220. Optionally, identification occurs each time that subscriber 210 downloads content from server 230. Optionally, the identification includes a UID-C.

As described above, content providers 250 optionally comprise advertisers 260 so that at least a portion of the content items comprise advertisements.

In an exemplary embodiment of the invention, subscriber interface 736 is configured to include an advertisement 356 in a content item provided by a content provider 250 that is not an advertiser according to campaign rules 354.

In an exemplary embodiment of the invention, server 230 comprises a fee determination module 738. Optionally, fee determination module 738 is configured to determine a fee which includes a portion for payment to one or more of content provider 250, mobile phone service provider 220 and an operator of the server 230. In an exemplary embodiment of the invention, the fee determination module is configured to determine a fee which includes a portion for payment to an owner of rights to the content other than content provider 250. In an exemplary embodiment of the invention, server 230 includes a rights compliance module 750 configured to credit an account 760 of the owner of rights in accord with an instruction issued by fee determination module. Optionally, the instruction is relayed via billing module 638. Optionally, performance of the instruction is conditional upon collection of a fee from service provider account 620.

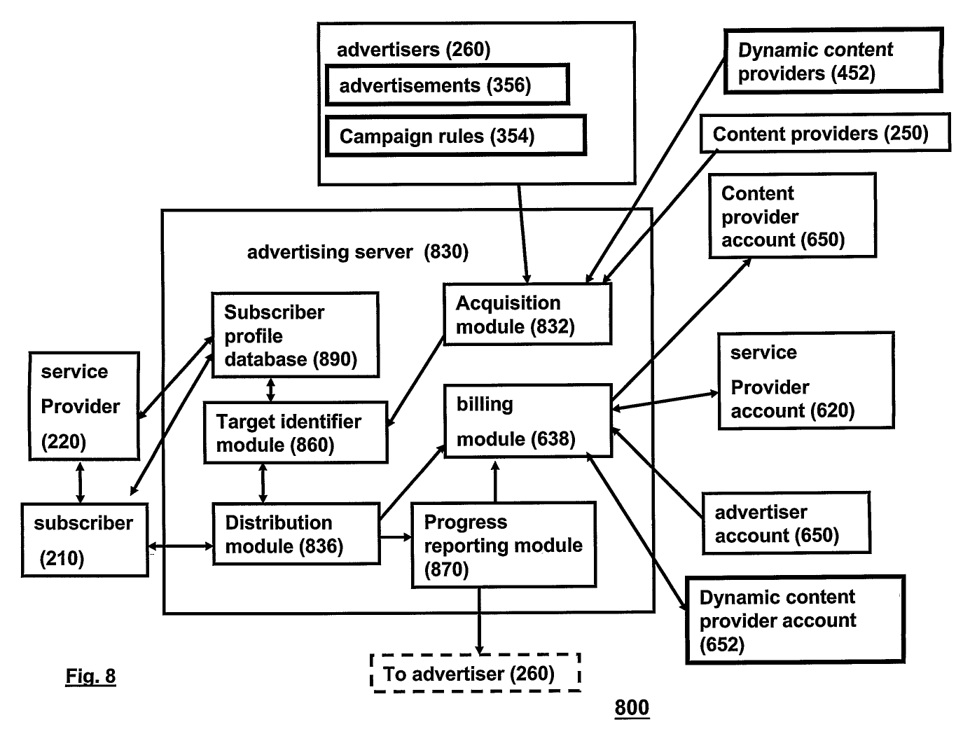

FIG. 8 illustrates another exemplary system architecture 800 for a network adapted to distribute advertising content directly to mobile phone subscribers 210 through their handsets. In the depicted embodiment, server 830 comprises an acquisition module 832, a target identifier module 860, a distribution module 836, a subscriber profile database 890 and a progress reporting module 870. Billing module 638 is similar in its operational capacity to similar modules depicted in FIGS. 6 and 7 and described above.

In an exemplary embodiment of the invention, advertising server 830 includes acquisition module 832 configured to receive and store advertising content 356 from one or more advertisers 260 and distribution module 836 configured to distribute advertising content 356 to handsets of subscribers 210 belonging to a plurality of mobile phone service providers 220.

Optionally, distribution module 836 distributes advertising content 356 in accord with one or more campaign rules 354 specified by advertiser 260 providing content 356. Rules 354 optionally include temporal constraints and/or a designation of a number of subscribers 210 to receive advertising content 356. Optionally, a subscriber profile data base 890 stores subscriber profiles 590 of subscribers 210 belonging to a plurality of mobile phone service providers 220. Exemplary methods of compiling profiles 590 are describe above in the context of FIG. 5. In an exemplary embodiment of the invention, rules 354 stipulate at least one subscriber characteristic from profile 590 as a constraint on distribution of advertising content 356.

In an exemplary embodiment of the invention, server 830 includes target identifier module 860 configured to communicate at least one desired subscriber characteristic to a plurality of mobile phone service providers and to receive from the mobile phone service providers phone numbers of subscribers that comply with the desired subscriber characteristic. In the depicted embodiment, communication is through database 890.

In an exemplary embodiment of the invention, server 830 includes progress reporting module 870 configured to issue a report to an advertiser 260 on a degree of progress towards a goal defined by campaign rule 354.

Optionally, distribution module 836 is configured to distribute interstitial advertisements and/or distribute banner advertisements and/or advertisements comprising a phone prompt. In an exemplary embodiment of the invention, advertising content 356 is included in non-advertising content from dynamic content providers 452 and/or other content providers 250. Inclusion can optionally be performed by acquisition module 832 and/or distribution module 836.

### Exemplary Content Distribution Method

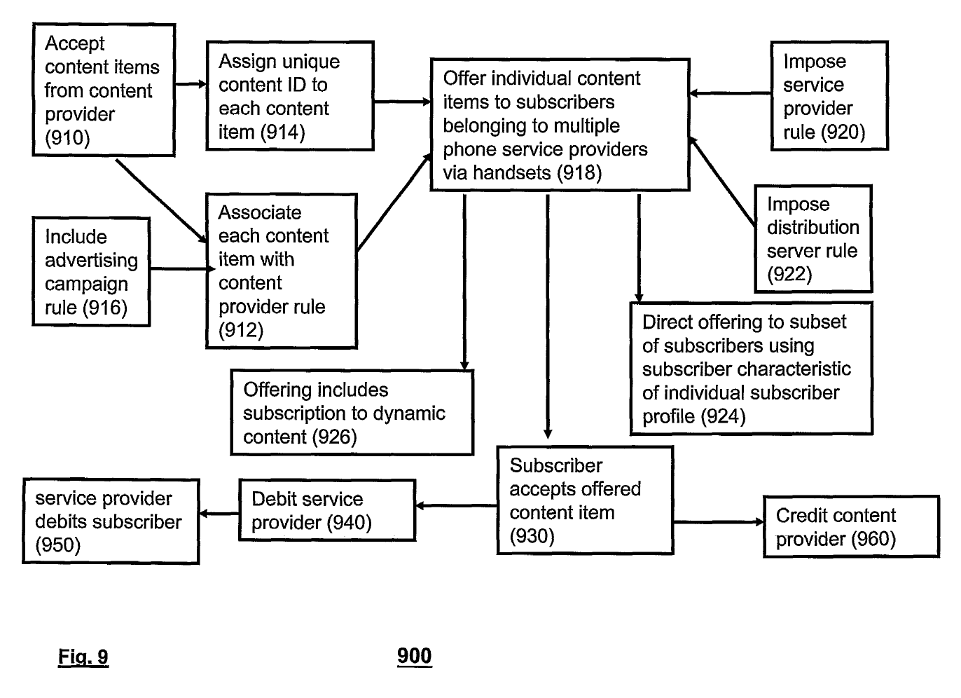

FIG. 9 illustrates another exemplary method 900 of distributing mobile phone content to subscriber handsets over a network.

At 910, a network server accepts content from content providers. The server assigns 914 a unique identifier (UID-C) to each content item and associates 912 each content item with a content provider rule. In some embodiments of the invention, a portion of the content includes advertising and advertising campaign rules are included 916.

At 918, the network server offers individual content items to individual subscribers belonging to a plurality of phone service providers via their handsets in accord with the content provider distribution rule of 912. Optionally, offering 918 can be directly to subscribers via the network server, or via an portal operated by a mobile phone service provider.

At 920, the service provider imposes a rule as a condition for the offering.

At 922, the server imposes a content server rule as a condition for the offering. 924 indicates that offering 918 is optionally directed to a subset of individual subscribers based upon individual subscriber profiles and at least one subscriber characteristic specified in a content provider distribution rule at 912 and/or 916.

According to some exemplary embodiments of the invention, some of the individual content items can include dynamic content. Optionally, offering 918 includes making 926 a dynamic content subscription available to the subscribers belonging to the plurality of phone service providers. Optionally, the dynamic content subscription provides notice of changes in dynamic content via the handsets of the subscriber.

In response to offer 918, a subscriber accepts 930 one or more offered content items. In response to acceptance 930, the subscriber's service provider is debited 940. Optionally, the service provider debits 950 the subscriber, although the content provider and/or server are not involved in this step.

In response to acceptance 930, the content provider for the accepted content item is credited 960. In the case of advertising content items, an advertiser may be debited for the acceptance.

Components (e.g. various modules) and/or actions described/depicted as single units may, in actuality, be divided into sub-units which act in concert to perform the described/depicted function. Alternately or additionally, components and/or actions described/depicted as separate units may, in actuality, be combined into a compound unit which performs the described/depicted functions. In particular, method steps described/depicted separately may be performed by a single piece of hardware and/or software program. Alternately or additionally, components depicted as physical units may be provided as software or firmware installations.

Disclosed methods may optionally be provided as software instructions for data processing circuitry, as firmware or hardware configured to perform the method. Machine readable media including instructions for performance of a described method is within the scope of the invention.

Features described in the context of a method can be used to characterize hardware devices.

Features described in the context of a hardware device can be used to characterize a method.

In addition individual features described herein can be used together, separately or in various sub-combinations. Alternatively or additionally, features described in the context of an apparatus may be applied to a method, and features described in the context of a method may be applied to an apparatus.

The terms “include”, “comprise” and “have” and their conjugates as used herein mean “including but not necessarily limited to”.

For purposes of this specification and the accompanying claims, the terms “debit” and “bill” are used interchangeably.

For purposes of this specification and the accompanying claims, the terms “credit” and “pay” are used interchangeably.

The examples presented in the text and/or depicted in the figures are not intended to limit the scope of the invention, which is defined only by the following claims.

1-73. (canceled)

74. A network adapted to distribute content to mobile phone service providers, the network comprising:
(a) an acquisition module configured to receive and store content items from at least one content provider, assign a unique content identifier to each of the content items and associate each content item with a content provider rule;
(b) a query module configured to receive content requests from a plurality of mobile phone service providers, each request associated with a service provider rule; and
(c) a distribution module configured to compare each of the content items with the service provider rule and make available to each service provider content items in accord with the content provider rule and the service provider rule.

75. A network according to claim 74, comprising:
(d) a billing module configured to debit an account of a service provider and credit an account of a content provider.

76. A network according to claim 75, wherein the billing module debits the account of the service provider in accord with the service provider rule, or credits the account of the content provider in accord with the content provider rule, or responds to a notice from a service provider that a content item has been distributed to a subscriber.

77. A network according to claim 74, wherein the service provider rule stipulates a price, or the content provider rule stipulates a price, or the content provider rule stipulates a distribution area, or the content provider rule stipulates a number of times that the content can be distributed to subscribers to service providers, or wherein at least a portion of the content providers comprise advertisers and at least a portion of the content items comprise advertisements, or wherein at least a portion of the content provider rules comprise campaign rules.

78. A network according to claim 74, wherein the distribution module is configured to include an advertisement in a content item provided by a content provider that is not an advertiser.

79. A network according to claim 74, wherein the content provider rule comprises a campaign rule and there is further provided a billing module configured to debit an account of an advertiser in accord with the campaign rules.

80. A network according to claim 74, wherein at least a portion of the content providers provide dynamic content and at least a portion of the content items comprise the dynamic content.

81. A network according to claim 80, wherein the service provider rules permit distribution of dynamic content to subscribers of the service provider based upon a dynamic content subscription.

82. A server adapted to distribute content to mobile phone handsets, the server comprising:
(a) an acquisition module configured to receive and store content items from a plurality of content providers, assign a unique content identifier to each of the content items and associate each content item with a content provider rule;
(b) an authorization module configured to receive a guarantee from a mobile phone service provider that the service provider will pay for any content requested by its subscribers and to designate the mobile phone service provider as an authorized service provider; and
(c) a subscriber interface configured to offer content to subscribers belonging to an authorized service provider for a fee.

83. A server according to claim 82, comprising;
(d) a fee determination module.

84. A server according to claim 83, wherein the fee determination module is configured to determine a fee which includes a portion for payment to the content provider.

85. A server according to claim 83, wherein the fee determination module is configured to determine a fee which includes a portion for payment to the mobile phone service provider.

86. A server according to claim 83, wherein the fee determination module is configured to determine a fee which includes a portion for payment to an operator of the server.

87. A server according to claim 83, wherein the fee determination module is configured to determine a fee which includes a portion for payment to an owner of rights to the content other than the content provider.

88. A server according to claim 87, comprising:
(e) a rights compliance module configured to credit an account of the owner of rights in accord with an instruction issued by the fee determination module.

89. An advertising server adapted to distribute advertisements to mobile phone handsets, the server comprising:
(a) an acquisition module configured to receive and store advertising content from one or more advertisers;
(b) a distribution module configured to distribute the advertising content to handsets of subscribers belonging to a plurality of mobile phone service providers.

90. A server according to claim 89, wherein said distribution module is operable using at least one campaign rule, and said campaign rule comprises a temporal constraint on distribution of the advertising content, or said campaign rule comprises a designation of a number of subscribers to receive the advertising content, or said campaign rule comprises at least one subscriber characteristic as a constraint on distribution of the advertising content.

91. A server according to claim 89, comprising:
(c) a target identifier module configured to communicate at least one desired subscriber characteristic to a plurality of mobile phone service providers and to receive from the mobile phone service providers phone numbers of subscribers that comply with the desired subscriber characteristic.

92. A server according to claim 90, comprising:
(c) a progress reporting module configured to issue a report to an advertiser on a degree of progress towards a goal defined by the campaign rule.

93. A server according to claim 89, wherein the distribution module is configured to distribute interstitial advertisements, or to distribute banner advertisements, or to distribute advertisements comprising a phone prompt.

94. A method of distributing mobile phone content, the method comprising:
(a) accepting a plurality of individual content items from at least one content provider and associating a content provider distribution rule with each individual content item;
(b) offering the individual content items to individual subscribers belonging to a plurality of phone service providers via their handsets in accord with the content provider distribution rule.

95. A method according to claim 94, comprising:
(c) assigning a unique content identifier (UID-C) to each individual content item.

96. A method according to claim 94, wherein the offering is through a mobile phone service provider, or wherein the offering is through a content server.

97. A method according to claim 96, comprising:
imposing a service provider rule as a condition for the offering, or imposing a content server rule as a condition for the offering.
